(19) United States
(12) Patent Application Publication
(10) Pub. No.: US 2025/0146716 A1
(43) Pub. Date: May 8, 2025

(54) Additively Manufactured Vascular Networks

(71) Applicant: The Government of the United States of America, as represented by the Secretary of the Navy, Arlington, VA (US)

(72) Inventors: Matthew Wiese, Washington, DC (US); Bradley Segelhorst, Washington, DC (US); John Montgomery, Washington, DC (US)

(73) Assignee: The Government of the United States of America, as represented by the Secretary of the Navy, Arlington, VA (US)

(21) Appl. No.: 18/939,235

(22) Filed: Nov. 6, 2024

Related U.S. Application Data
(60) Provisional application No. 63/596,373, filed on Nov. 6, 2023.

(51) Int. Cl. F25B 39/04; B33Y 10/00; B33Y 40/20; B33Y 80/00; F28F 21/06

(52) U.S. Cl. CPC F25B 39/04; B33Y 40/20; B33Y 80/00; F28F 21/062; B33Y 10/00; F25B 2339/04; F28F 2210/02

(57) ABSTRACT

Systems and methods are provided for additively manufactured vascular networks that can allow for large areas of a plate or structure to be maintained at a constant and even temperature throughout a wide range of applied heat loads, even if the heat load is applied only on portions of the surface. An additively manufactured vascular network in accordance with an embodiment of the present disclosure is a cost effective way of adding this thermal management solution over other more labor intensive options or methods with higher initial costs. Applications for additively manufactured vascular networks in accordance with an embodiment of the present disclosure can be found in a wide range of land, sea, air, and space environments.

### CROSS REFERENCE TO RELATED APPLICATIONS

This application claims the benefit of U.S. Provisional Patent Application No. 63/596,373, filed on Nov. 6, 2023, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; nrltechtran@us.navy.mil, referencing Navy Case Number 211855-US2.

### FIELD OF THE DISCLOSURE

This disclosure relates to thermal management, including heat dissipation.

### BACKGROUND

In many high-performance systems, proper management of temperatures due to high thermal loads (both system-generated and externally applied) is critical and requires a dedicated thermal system to acquire, transport, and reject the heat. These systems are found in many military and commercial technologies, ranging from the coolant loop in a typical internal combustion-powered vehicle to the heat pipes and fan-assisted radiators found in high performance computers.

These heat collection and rejection methods generally increase the complexity of the greater system, add mass, and serve the singular purpose of thermal management. Additionally, some conventional systems lack high pressure performance (>300 psi) and can be costly when multiple unique designs are required.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a diagram of a vasculature in accordance with an embodiment of the present disclosure;

FIG. 2 is a diagram of a manifold on a build platform in accordance with an embodiment of the present disclosure;

FIG. 3 is a diagram of a Formlabs Form 3L Printer in accordance with an embodiment of the present disclosure;

FIG. 4 is a diagram showing an 8″ 4 channel burst sample of FormLabs high temp resin in accordance with an embodiment of the present disclosure;

FIG. 5 is a diagram showing an 8″ 4 channel burst sample of PETG printed using FDM in accordance with an embodiment of the present disclosure;

FIG. 6 is a diagram showing 1 ft×2 ft lab-testing networks qty 4 SLA printed using FormLabs rigid 10K material in accordance with an embodiment of the present disclosure;

FIG. 7 is a diagram of an exemplary cross sectional area in accordance with an embodiment of the present disclosure;

FIG. 8 is a diagram of another exemplary cross sectional area in accordance with an embodiment of the present disclosure;

FIG. 9 is a diagram of an initial test sample computer aided design (CAD) model and descriptive sample dimensions of a tube cross section in accordance with an embodiment of the present disclosure;

FIG. 10 shows images of initial test samples of 0.10″, 0.141″, and 0.282″ (from top to bottom) internal diameter with a 0.040″ wall thickness printed using tough resin 1500 on a FormLabs 3 SLA printer in accordance with an embodiment of the present disclosure.

FIG. 11 shows an image of an initial test sample of 0.10″ cross section after structural burst testing in accordance with an embodiment of the present disclosure;

FIG. 12 is a diagram showing initial test results of simple tube geometries plotted against ideal analytical expectations in accordance with an embodiment of the present disclosure;

FIG. 13 is a diagram showing an idealized sample vasculature based off of conservation of area for an 8 channel sample in accordance with an embodiment of the present disclosure;

FIG. 14 is a diagram of a CAD model of a sample three dimensional (3D) printed vascular network including 8 channels of 0.060″ cross section in accordance with an embodiment of the present disclosure;

FIG. 15 is a diagram of a 3D printed sample vascular network printed using tough resin 1500 on a FormLabs Form 3 SLA printer in accordance with an embodiment of the present disclosure;

FIG. 16 is a diagram of a zoomed in an backlit view of a sample vascular network showing the presence of internal geometry in accordance with an embodiment of the present disclosure;

FIG. 17 is a diagram showing thermal camera imaging of a 3D-printed vascular network sample when cold gaseous nitrogen was flowed through the sample in accordance with an embodiment of the present disclosure;

FIG. 18 is an image of a circulation pimp and isopropanol used for clearing out uncured resin from a desired completed sample in accordance with an embodiment of the present disclosure;

FIG. 19 is a diagram of a conceptualized figure of resin removal using small ferrous spheres and a magnet in accordance with an embodiment of the present disclosure;

FIG. 20 is a diagram of a flowchart for simplified development and manufacturing flow of additively manufactured panels in accordance with an embodiment of the present disclosure;

FIG. 21 is a diagram showing optional placement of a vascular structure within a vapor compression cycle system in accordance with an embodiment of the present disclosure;

FIG. 22 is a diagram of a flowchart for creating a vascular network structure in accordance with an embodiment of the present disclosure;

FIG. 23 is a diagram showing an integrated inlet/outlet of an additively manufactured vascular network in accordance with an embodiment of the present disclosure;

FIG. 24 is a diagram of modular components of an additively manufactured vascular network in accordance with an embodiment of the present disclosure;

FIG. 25 is a diagram showing a boding interface for bonding of modular components of an additively manufactured vascular network in accordance with an embodiment of the present disclosure;

FIG. 26 is a flowchart of an exemplary method for bonding modular components of an additively manufactured vascular network in accordance with an embodiment of the present disclosure;

FIG. 27 is a diagram showing assembly of modular components of an additively manufactured vascular network in accordance with an embodiment of the present disclosure; and

FIG. 28 is a thermal camera image for thermal testing of an additively manufactured vascular network in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. Overview

Embodiments of the present disclosure provide additively manufactured vascular networks that can allow for large areas of a plate or structure to be maintained at a constant and even temperature throughout a wide range of applied heat loads, even if the heat load is applied only on portions of the surface. An additively manufactured vascular network in accordance with an embodiment of the present disclosure is a cost effective way of adding this thermal management solution over other more labor intensive options or methods with higher initial costs. Applications for additively manufactured vascular networks in accordance with an embodiment of the present disclosure can be found in a wide range of land, sea, air, and space environments.

An additively manufactured vascular network in accordance with an embodiment of the present disclosure can provide an embedded and coupled thermal management solution of a structure or components that mount to it rather than a traditional cold plate or bolt on thermal management solutions.

An additively manufactured vascular network in accordance with an embodiment of the present disclosure can reduce thermal distortions of large space or terrestrial-based structures by preventing large thermal gradients across the surface of a structure of portion of a large surface where significant heat acquisition and transport is required.

### 2. Exemplary Additively Manufactured Vascular Networks

An additively manufactured vascular network in accordance with an embodiment of the present disclosure can include a series of branching or non-branching channels stemming from a single or series of inlets. These flow paths can expand to a consistent heat collection/rejection region of parallel or otherwise oriented channels that encompasses the region or surface whose temperature needs to be controlled. Those channels can then be collected back to a single or series of outlets via a similar branching method.

This network can ideally be placed within a single and/or two-phase thermal system acting as the evaporator or heat collector but could alternatively be utilized as the condenser or heat rejecter. In an embodiment, due to the fluid moving through the network, the network can be considered as a pressure vessel and should not leak and allow for fluid to move from the inlet(s) to the outlet(s).

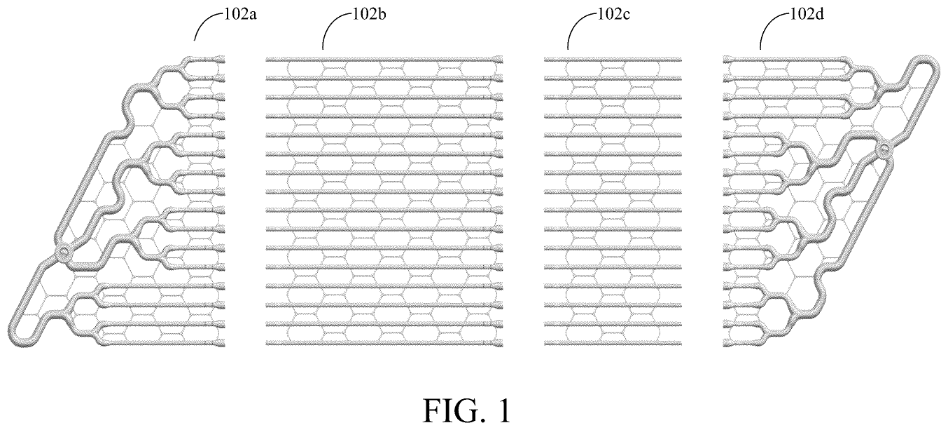

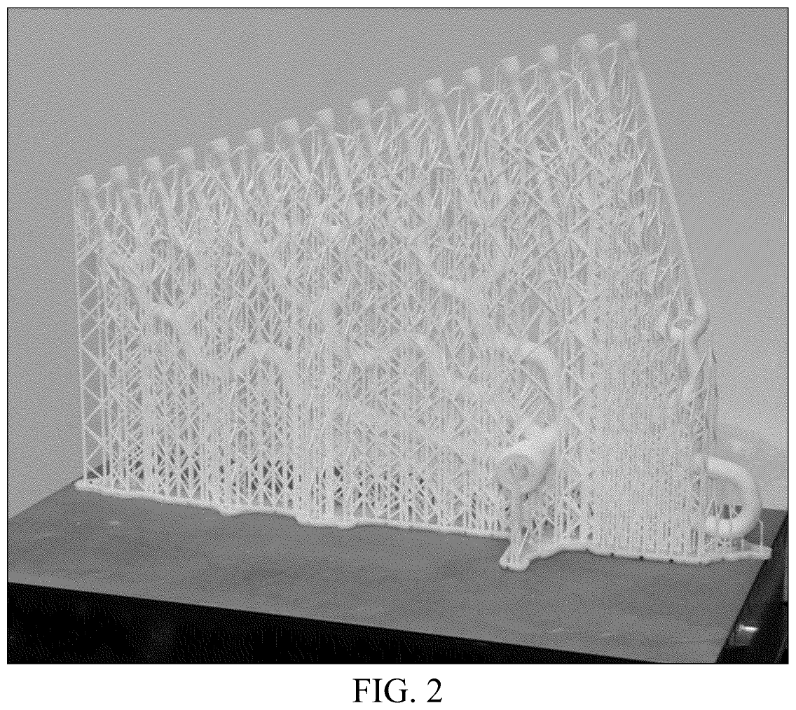

FIG. 1 is a diagram of a vasculature in accordance with an embodiment of the present disclosure. In an embodiment, the vasculature of FIG. 1 is 28″ long. In an embodiment, the vasculature of FIG. 1 has 4 parts 102 that can fit together. FIG. 2 is a diagram of a manifold on a build platform in accordance with an embodiment of the present disclosure.

In an embodiment, the methods for producing a vascular network to carry fluid for heating or cooling purposes utilizing additive manufacturing technology (e.g., three dimensional (3D) printing), include but are not limited to, stereolithography (SLA), selective laser sintering (SLS), and fused deposition modeling (FDM). This manufacturing technology allows for highly complex networks structures specifically tailored for its application utilizing design methods such as variable wall thickness, variable cross sectional geometry and complex geometry designed through traditional or generative processes. An example of these complex geometries would be to allow for out of plane variations of the flow path, such as the same network being placed on opposing sides of a plate between the inlet and outlet. Alternatively, complex curvatures could be incorporated, such as by incorporating a network into tubing used for structural trusses or maintaining thermal stability within a telescopes primary mirror.

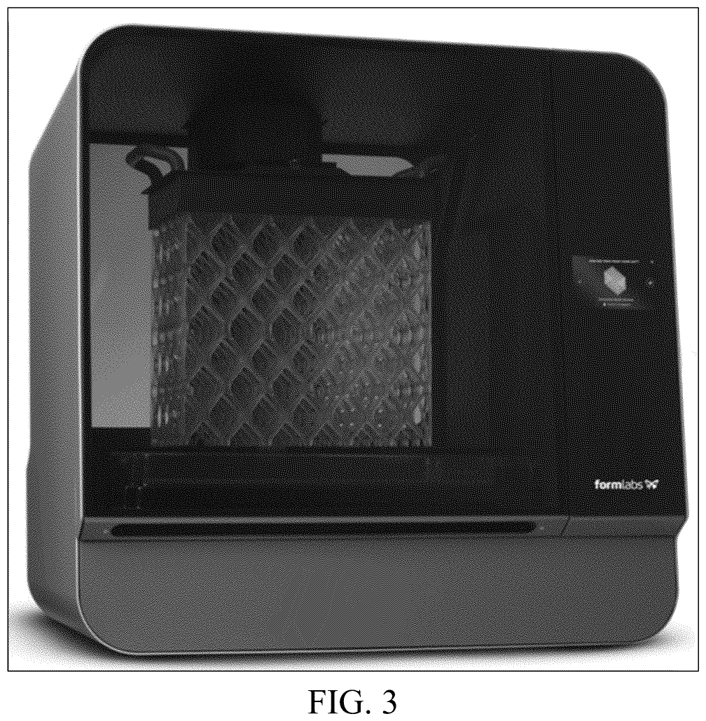

FIG. 3 is a diagram of a Formlabs Form 3L Printer in accordance with an embodiment of the present disclosure.

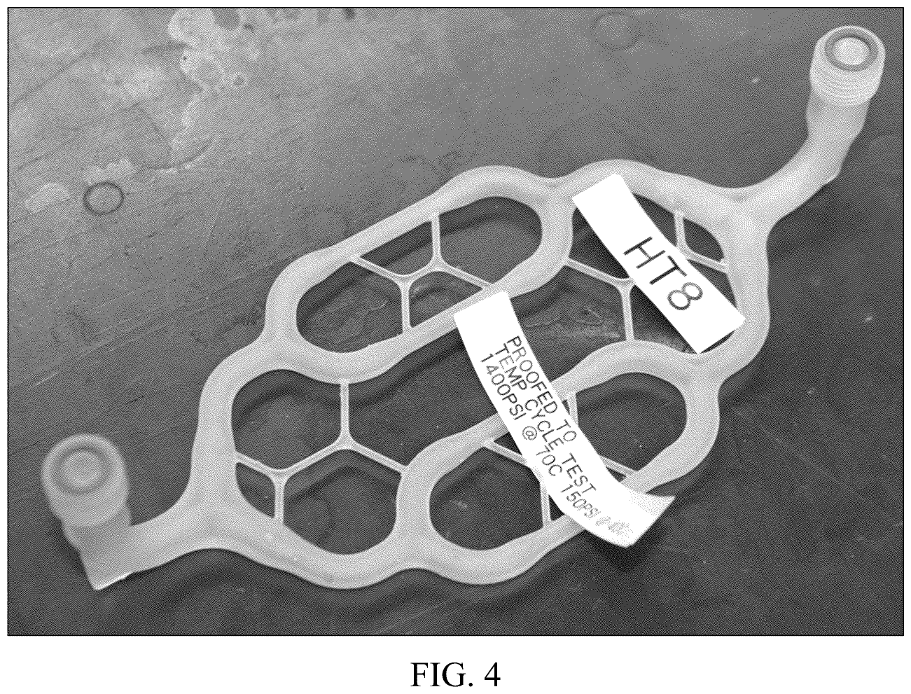

FIG. 4 is a diagram showing an 8″ 4 channel burst sample of FormLabs high temp resin in accordance with an embodiment of the present disclosure.

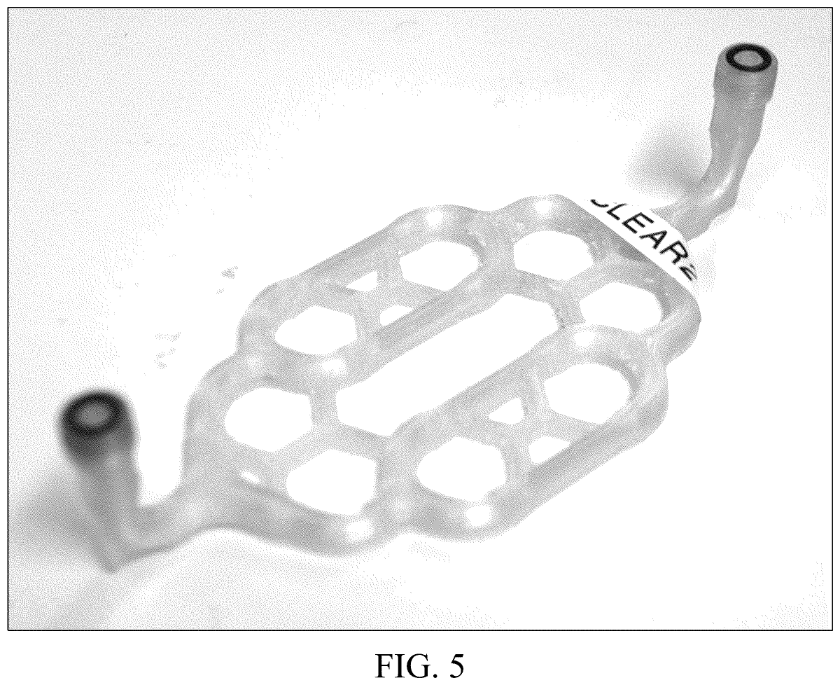

FIG. 5 is a diagram showing an 8″ 4 channel burst sample of PETG printed using FDM in accordance with an embodiment of the present disclosure.

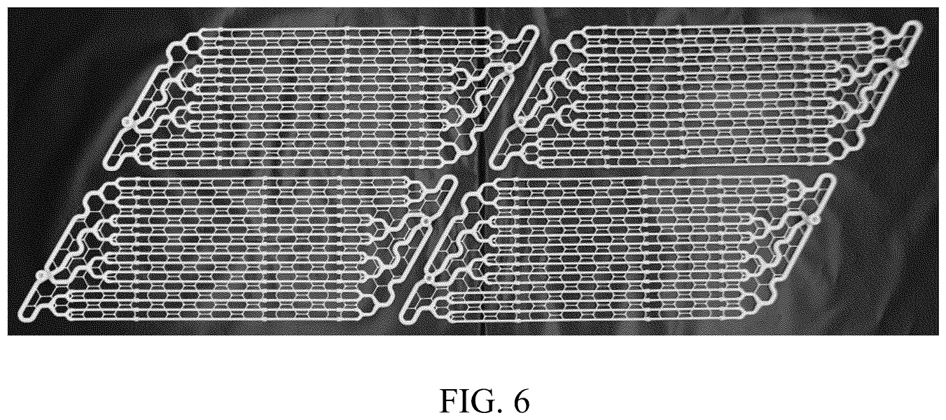

FIG. 6 is a diagram showing 1 ft×2 ft lab-testing networks quantity 4 SLA printed using FormLabs rigid 10K material in accordance with an embodiment of the present disclosure.

Depending on the specific manufacturing technique used, various post processing techniques are available to clear out fluid passageways after printing. For SLA technologies, this can involve removing uncured resin with processes, including but not limited to, flowing pressurized air, chemicals such as isopropyl alcohol (IPA), or abrasive slurry through the branched networks prior to final curing.

Alternatively, other mechanical methods can be used, such as ferrous spheres guided using magnets to clear blocked passageways from uncured resin. For SLS technologies, a similar process of flowing pressurizing air, chemicals, or abrasive slurry to remove un-sintered powder can be used. For FDM technologies, post printing chemical baths or thermal bake outs can be used to aid in layer adhesion prior to flowing pressurized fluid through the branched networks.

Upon completion of the additively manufactured network, it can be used in isolation as a stand-alone unit. In an embodiment, an additively manufactured network can be embedded or cast into a larger structure. For example, in the example of managing heat in a panel, it could be embedded within the foam core of a sandwich panel. In an embodiment, since it is capable of containing its own pressure the surrounding parent materials would not be necessary for providing additional structural properties but could be useful for heat rejection/collection.

An additional example of being cast in place would be embedding cooling channels into flexible substrates (silicone, rubber, etc.) for solar panels allowing them to be adhered to curved surfaces. Conversely, they could be cast in place within the surface prior to adhesion of the solar panels, such as a curved plaster wall/ceiling in architectural buildings.

Equation (1) below shows Barlow's formula for burst pressure (P) of a simple cylinder based off of a wall thickness (t), external diameter (D), and material ultimate stress (σᵤ).

$$P = \frac{2 {σ}_{u} t}{D} \qquad ( 1 )$$

### 3. Exemplary Features

An additively manufactured vascular network in accordance with an embodiment of the present disclosure can leverage 3D printing technology to create a fully customized fluid vasculature through which single or two phase flow can be introduced for the purposes of removing or introducing heat to the surrounding structure. By using additive manufacturing, a wide array of properties can be fully tailorable to the use case required by adjusting the geometry.

For example, additive manufacturing can use 3D printing to construct a 3D model of a vascular network based on a design input such as a computer aided design (CAD) model. In an embodiment, properties of vascular network can be tailored, such as by tailoring the vascular distribution method, tailoring a cross sectional area of the flow region, tailoring a shape of the cross section, tailoring a wall thickness for pressure containment, and including mounting features or other external features for fixturing/locating, etc.

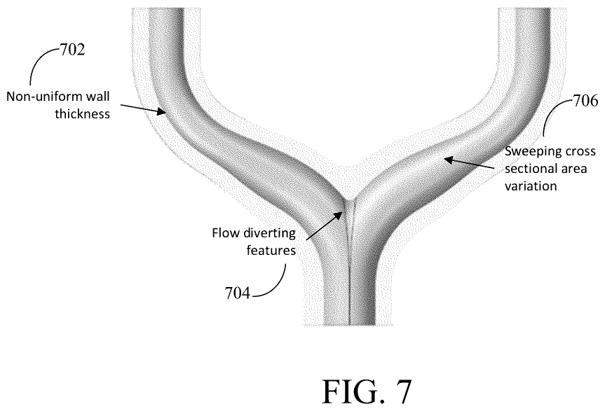

FIG. 7 is a diagram of an exemplary cross sectional area in accordance with an embodiment of the present disclosure. As show in FIG. 7, the additively manufactured vascular network has been tailored to produce a desired thermal management solution. In FIG. 7, this tailoring includes adjusting the vascular network to include a non-uniform wall thickness 702, flow diverting features 704, and a sweeping cross sectional area variation 706.

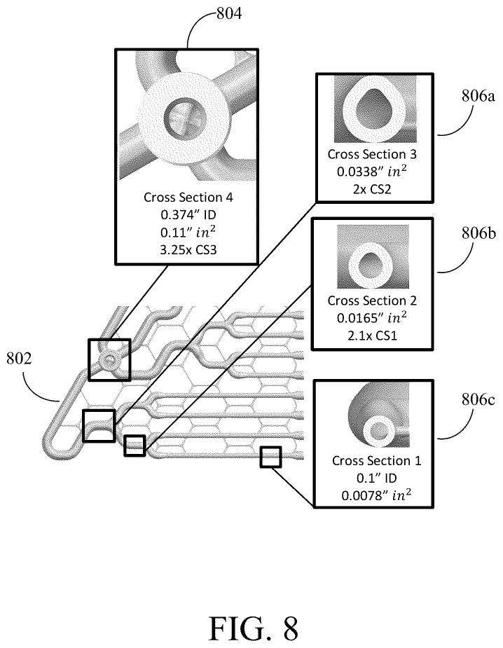

FIG. 8 is a diagram of another exemplary cross sectional area in accordance with an embodiment of the present disclosure. As show in FIG. 8, the additively manufactured vascular network 802 has been tailored to produce a desired thermal management solution. In FIG. 8, this tailoring includes adding a four-way flow area with specific dimensions 804 and adjusting the shape and dimensions of tubes to meet design requirements, as shown in cross sections 806.

As illustrated, for example, by FIG. 8, utilizing additive manufacturing technology in accordance with an embodiment of the present disclosure allows for branched fluid networks to be manufacturing with passageway cross sections that other methods are unable to achieve such as perfect circular, ob-round, or ellipsoidal structures. In an embodiment, this manufacturing approach removes the failing mode of peeling two layers apart when compared to similar passageways using thermoforming or composite layup manufacturing technology. Additive manufacturing also allows for more tailored geometry such as variable wall thickness (e.g., as shown in FIG. 8) to reduce weight and increase performance. With equal pressure distribution, smaller cross sections require thinner walls, and larger cross sections require thicker walls, and embodiments of the present disclosure allow for uniform safety factors. Embodiments of the present disclosure reduce overall part count since mechanical interfaces can be directly manufactured into the network as one piece. Flow control features can also be incorporated into the design more easily to allow for flow balancing from one channel to another.

### 4. Exemplary Systems

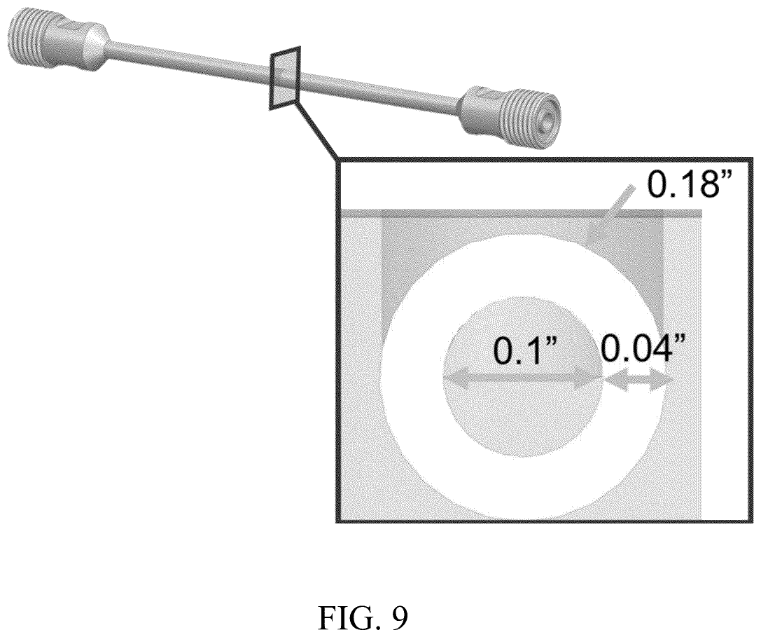

FIG. 9 is a diagram of an initial test sample computer aided design (CAD) model and descriptive sample dimensions of a tube cross section in accordance with an embodiment of the present disclosure.

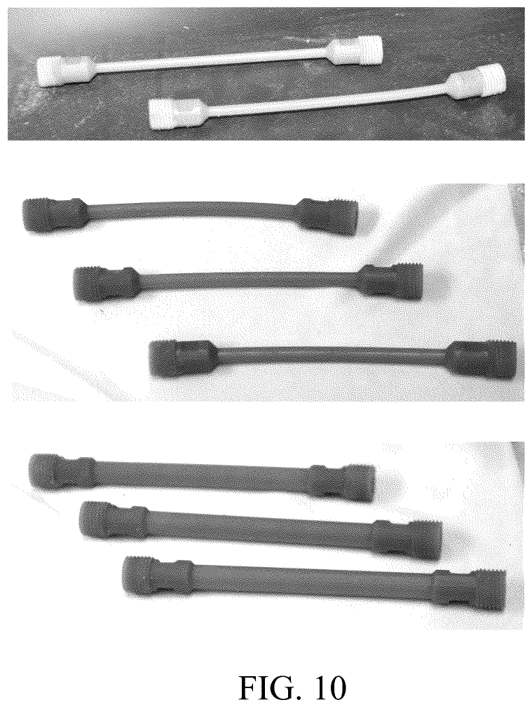

FIG. 10 shows images of initial test samples of 0.10″, 0.141″, and 0.282″ (from top to bottom) internal diameter with a 0.040″ wall thickness printed using tough resin 1500 on a FormLabs 3 SLA printer in accordance with an embodiment of the present disclosure.

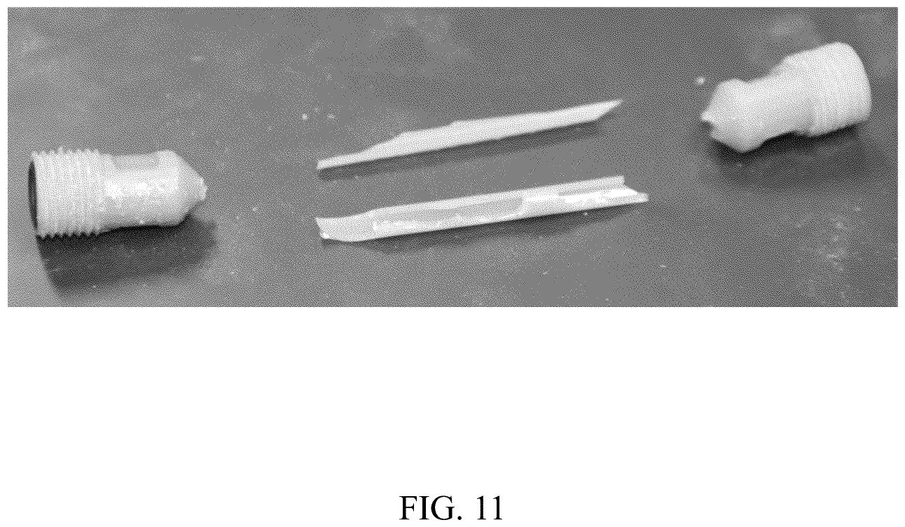

FIG. 11 shows an image of an initial test sample of 0.10″ cross section after structural burst testing in accordance with an embodiment of the present disclosure. The test sample of FIG. 11 exhibited expected failure mode in an expected region of a small tube cross section.

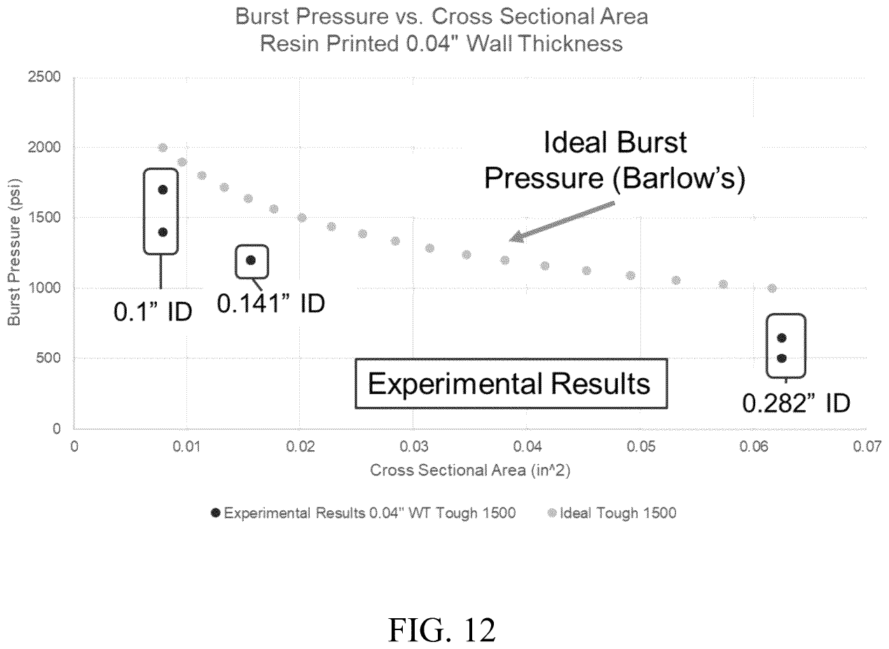

FIG. 12 is a diagram showing initial test results of simple tube geometries plotted against ideal analytical expectations in accordance with an embodiment of the present disclosure.

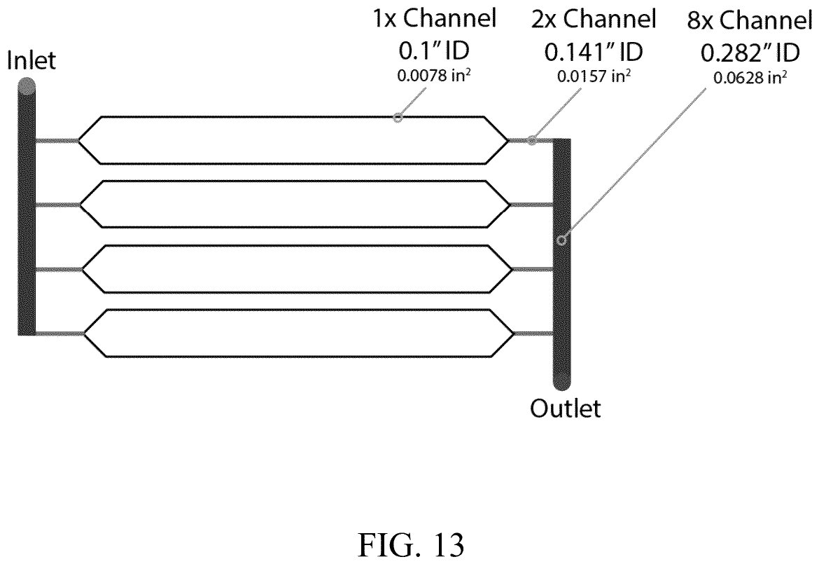

FIG. 13 is a diagram showing an idealized sample vasculature based off of conservation of area for an 8 channel sample in accordance with an embodiment of the present disclosure.

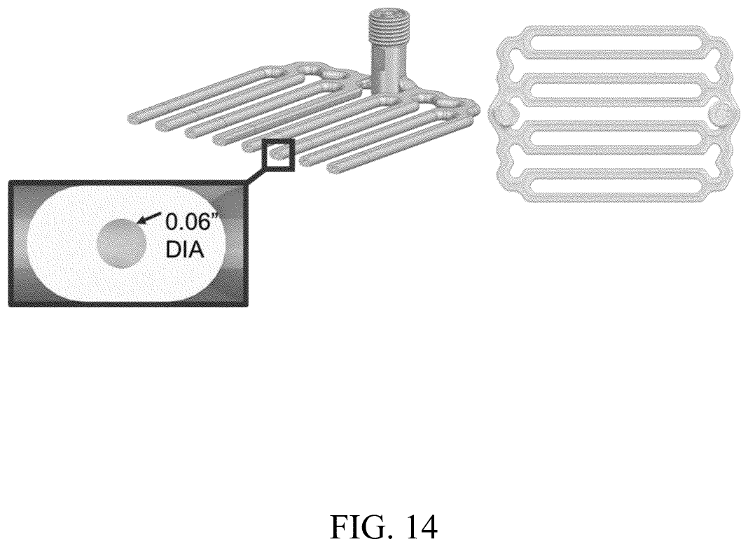

FIG. 14 is a diagram of a CAD model of a sample 3D printed vascular network including 8 channels of 0.060″ cross section in accordance with an embodiment of the present disclosure.

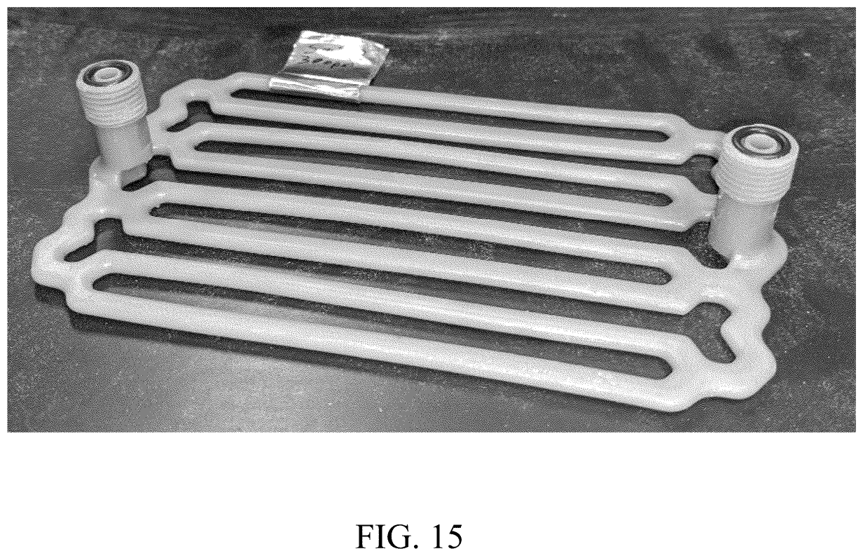

FIG. 15 is a diagram of a 3D printed sample vascular network printed using tough resin 1500 on a FormLabs Form 3 SLA printer in accordance with an embodiment of the present disclosure.

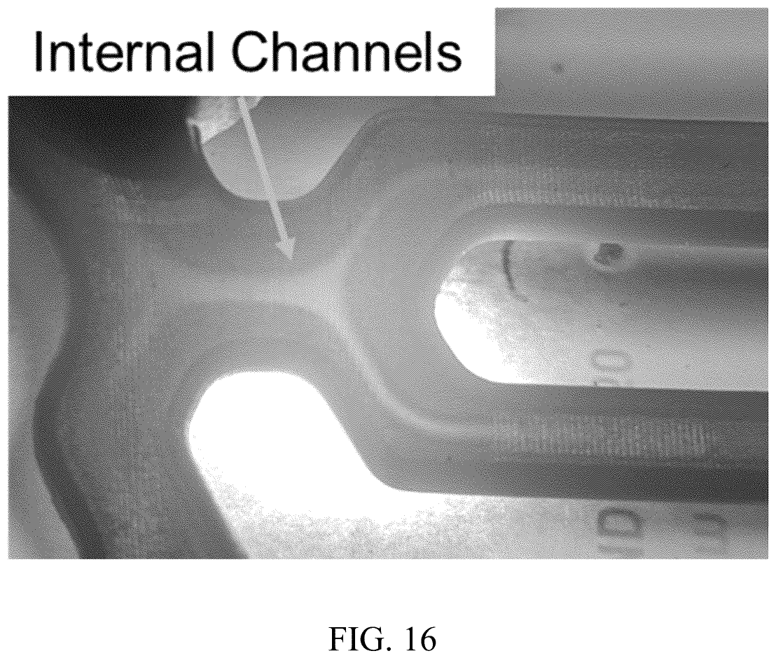

FIG. 16 is a diagram of a zoomed in and backlit view of a sample vascular network showing the presence of internal geometry in accordance with an embodiment of the present disclosure.

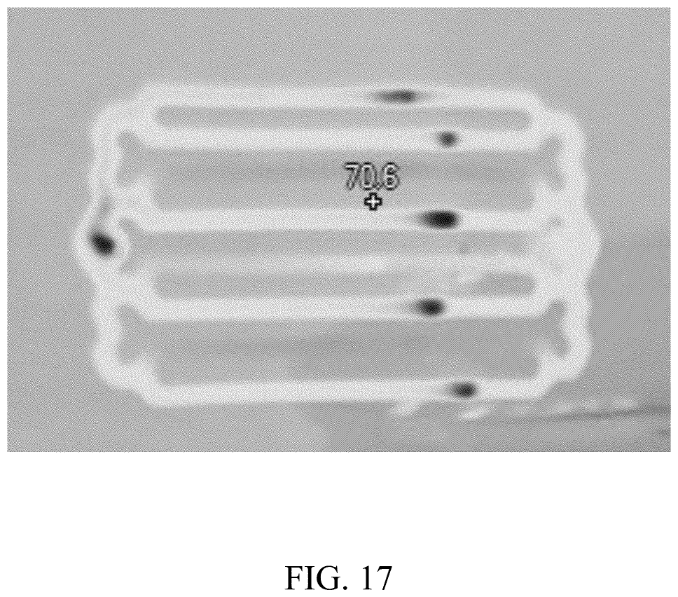

FIG. 17 is a diagram showing thermal camera imaging of a 3D-printed vascular network sample when cold gaseous nitrogen was flowed through the sample in accordance with an embodiment of the present disclosure. In FIG. 17, the channel located 3rd from the top and 2nd from the bottom are blocked, and the channel located 4th from the bottom is partially blocked.

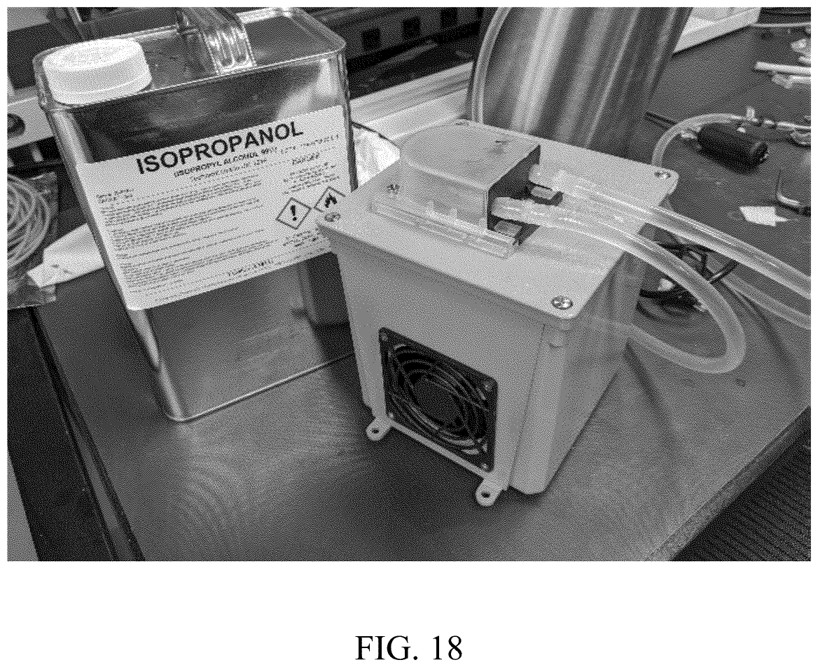

FIG. 18 is an image of a circulation pimp and isopropanol used for clearing out uncured resin from a desired completed sample in accordance with an embodiment of the present disclosure.

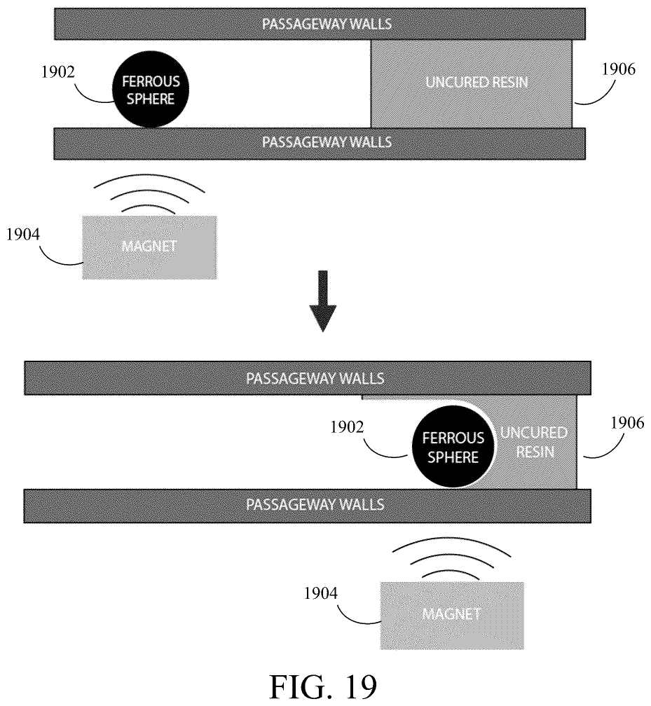

FIG. 19 is a diagram of a conceptualized figure of resin removal using small ferrous spheres and a magnet in accordance with an embodiment of the present disclosure. As shown in FIG. 19, a ferrous sphere 1902 can be moved through a passage using a magnet 1904 to remove uncured resin 1906.

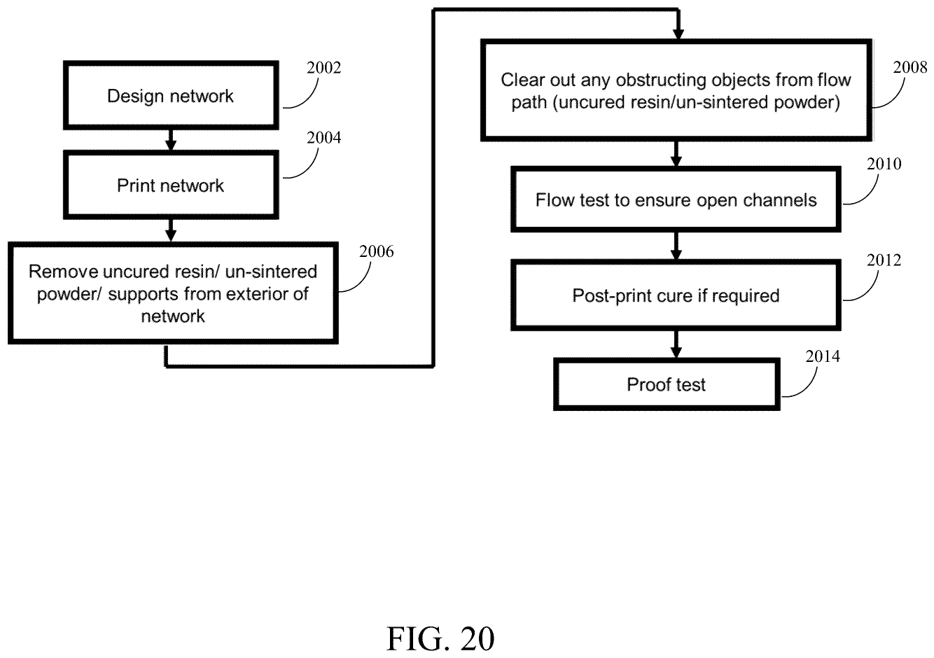

FIG. 20 is a diagram of a flowchart for simplified development and manufacturing flow of additively manufactured panels in accordance with an embodiment of the present disclosure.

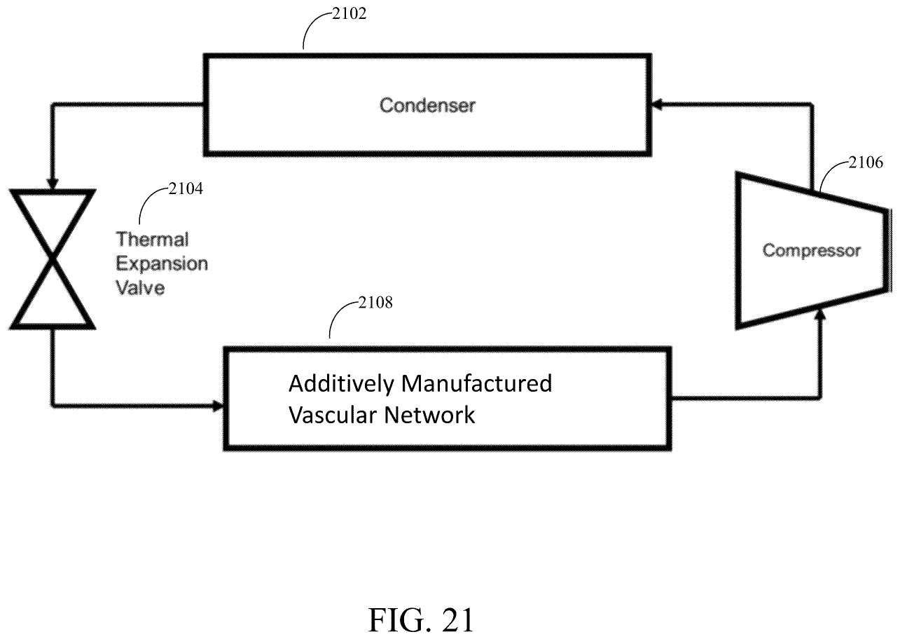

FIG. 21 is a diagram showing optional placement of a vascular structure within a vapor compression cycle system in accordance with an embodiment of the present disclosure.

### 5. Development and Placement of Additively Manufactured Vascular Network

FIG. 20 is a diagram of a flowchart for simplified development and manufacturing flow of additively manufactured panels in accordance with an embodiment of the present disclosure. In step 2002, the network is designed (e.g., using a CAD model). In step 2004, the network is printed (e.g., using a 3D printer). In step 2006, uncured resin, un-sintered powder, and/or supports from the exterior of the network are removed. In step 2008, any obstructing objects are cleared from the flow path (e.g., using small ferrous spheres as shown in FIG. 19). In step 2010, open channels are ensured using flow testing. In optional step 2012, a post-print cure is done if required. In optional step 2014, proof testing is done.

In an embodiment, the process utilized to create the network can be tailored using SLA/DLP printing, FDM printing, MJF or SLS printing in order to utilize the wide array of available materials and their respective properties. Depending on the process selected, post processing may be necessary to remove support material, such as de-powdering, removing supports, or pouring out uncured resin. Different printers can provide different build volumes allowing various size panels to be created, or various segments to be created that can be later adhered together via other methods. Upon completion of the network, it can be optionally cast into another material such as foam, silicone, or some other casting material in order to provide the additional structure or heat carrying capabilities.

FIG. 21 is a diagram showing optional placement of a vascular structure within a vapor compression cycle system in accordance with an embodiment of the present disclosure. As shown in FIG. 21, a vapor compression system can include a condenser 2102, a thermal expansion valve 2104, and a compressor 2106. As shown in FIG. 21, an additively manufactured vascular network 2108 in accordance with an embodiment of the present disclosure can be placed between the thermal expansion valve 2104 and the compressor 2106.

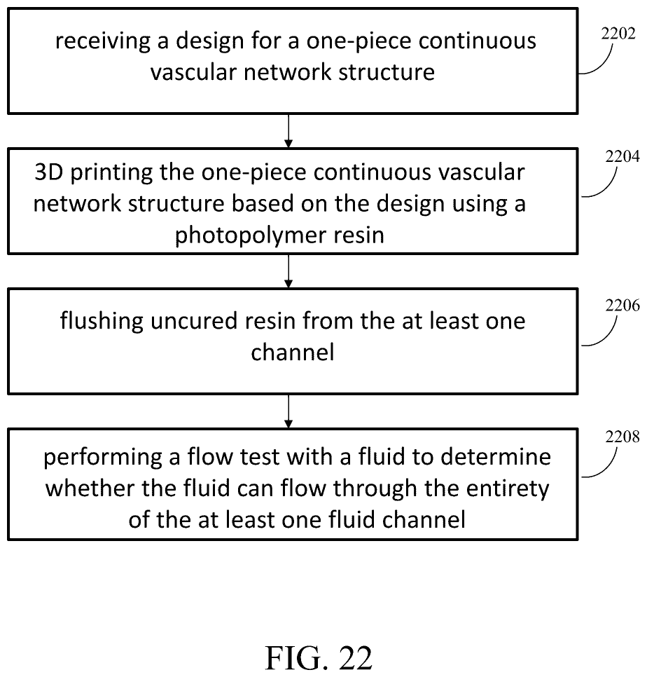

FIG. 22 is a diagram of a flowchart for creating a vascular network structure in accordance with an embodiment of the present disclosure. In step 2202, a design for a one-piece continuous vascular network structure is received. In an embodiment, the design defines an internal cavity that can be circular, ob-round, ellipsoidal, or of other cross sectional geometry. In an embodiment, the design defines varying wall thickness throughout a tubing in the one-piece continuous vascular network structure. In step 2204, the one-piece continuous vascular network structure is 3D printed based on the design using a resin. In an embodiment, the continuous vascular network structure defines at least one fluid channel extending through the continuous vascular network structure and at least one channel opening. In step 2206, uncured resin is flushed from the at least one channel. In step 2208, a flow test is performed with a fluid to determine whether the fluid can flow through the entirety of the at least one fluid channel.

In an embodiment, the continuous vascular network structure is cured. In an embodiment, a proofing test (e.g., pressure test) is conducted to determine structural integrity of the continuous vascular network structure. In an embodiment, a fluid is forced through the at least one fluid channel air or liquid to clear the uncured resin from the at least one channel. In an embodiment the flushing in step 2206 comprises inserting at least one magnetic object in the at least one channel opening and moving the at least one magnetic object through an entirety of the at least one fluid channel via magnetic force applied by a magnet, thereby clearing the uncured resin from the at least one fluid channel via the magnetic object.

In an embodiment, the one-piece continuous vascular network structure is a branching structure with multiple channels. In an embodiment, the one-piece continuous vascular network structure is configured to carry fluid at a temperature of between −40° C. and 70° C. In an embodiment, the one-piece continuous vascular network structure is configured to carry fluid at a temperature of over 70° C. In an embodiment, the one-piece continuous vascular network structure is configured to carry fluid at a temperature of below −40° C. In an embodiment, the one-piece continuous vascular network structure is configured to withstand an internal pressure of between 300-2000 pounds per square inch (psi). In an embodiment, the one-piece continuous vascular network structure is configured to carry 0-299 psi. Vacuum to at least 1e-4 torr has been demonstrated, as well as pressures up to 2200 psi. In an embodiment, desired pressure performance can be tailored and optimized via wall thickness and material choice. This is an advantage of the additive nature in that varying cross sections (volume/wall thickness) can be achieved without discrete transitions.

Embodiments of the present disclosure allow for a vascular cooling network to be produced in a single automated manufacturing step or with very simple post processing efforts requiring minimal human labor. Embodiments of the present disclosure reduce overall cost by being less labor intensive and utilizing relatively low cost materials. Embodiments of the present disclosure increase performance by allowing full tailoring of materials and geometry to the specific application, vs. minimum criteria that needed to be met for Vascular Composites and Thermoformed Composite Structure methods.

### 6. Exemplary Advantages of Additively Manufactured Vascular Networks

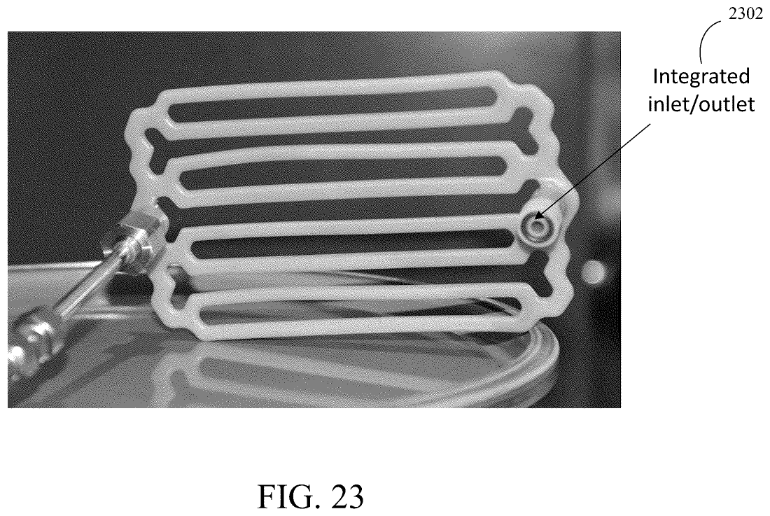

FIG. 23 is a diagram showing an integrated inlet/outlet 2302 of an additively manufactured vascular network in accordance with an embodiment of the present disclosure.

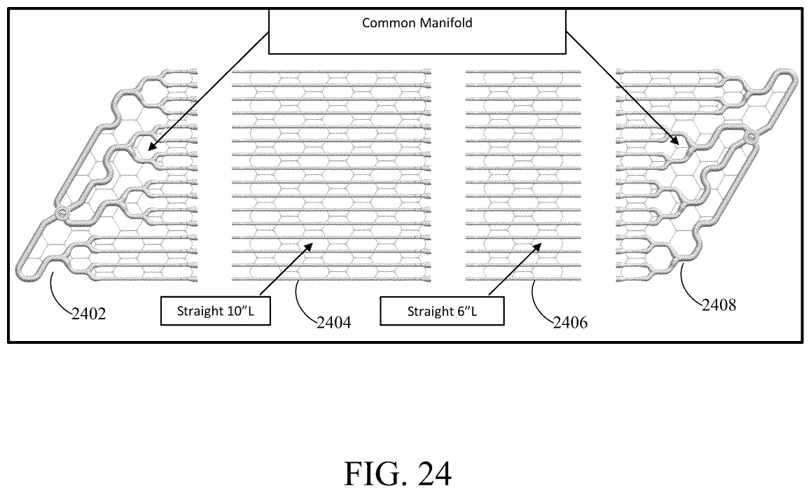

FIG. 24 is a diagram of modular components of an additively manufactured vascular network in accordance with an embodiment of the present disclosure. The additively manufactured vascular network shown in FIG. 24 has 4 modular components: a left piece 2402, a straight 10″ piece 2404, a straight 6″ piece 2406, and a right piece 2408.

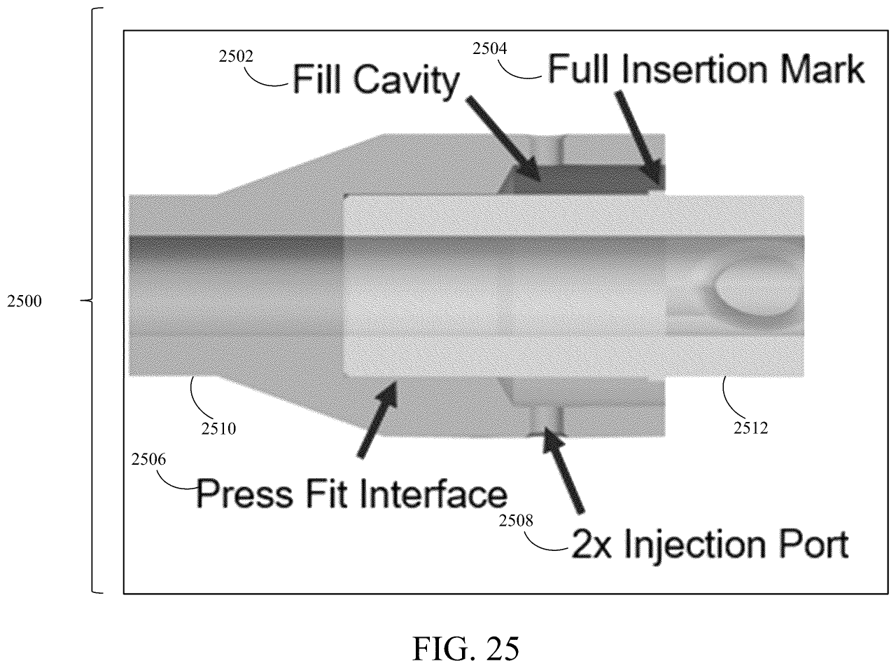

FIG. 25 is a diagram showing a bonding interface for bonding of modular components of an additively manufactured vascular network in accordance with an embodiment of the present disclosure. As shown in FIG. 25, an additively manufactured vascular network in accordance with an embodiment of the present disclosure can have one or more bonding interface(s) for bonding modular components together. For example, bonding interface 2500 shown in FIG. 25 can be used to bond modular components 2402, 2404, 2406, and/or 2408 shown in FIG. 24 together. In an embodiment, a first end 2510 of a first modular component can contain bonding interface 2500, and bonding interface 2500 can interface with a second end 2512 of a second modular component. For example, in an embodiment, bonding interface 2500 can be positioned at a right end of straight 10″ piece 2404 and can interface with a left end of straight 6″ piece 2406 to bond straight 10″ piece 2404 and straight 6″ piece 2406 together.

In FIG. 25, bonding interface 2500 includes a fill cavity 2502, a full insertion mark 2504, a press fit interface 2506, and an injection port 2508 (e.g., a 2x injection port). In an embodiment, first end 2510 can contain bonding interface 2510, and second end 2512 can slot into first end 2510 using press fit interface 2506. In an embodiment, these fitted ends can be bonded together using a bonding material to fill cavity 2502 by injecting the bonding material into injection port 2508 (e.g., using a syringe) until the bonding material fills fill cavity 2502 to full insertion mark 2504. In an embodiment, “2x injection port” refers to 2 (or more) injection ports that can be located on both sides (e.g., front and back) of bonding interface 2500, and the bonding material can be injected into both injection ports (e.g., using a syringe) until the bonding material fills fill cavity 2502 to full insertion mark 2504. However, it should be understood that, in an embodiment, only one injection port may be present and can be used to fill both sides with bonding material. In an embodiment, no injection ports are present, and bonding material can be injected into fill cavity 2502 (e.g., through press fir interface 2506). Using the bonding system(s) and method(s) described herein with reference to FIG. 25, any number of modular components can be bonded together.

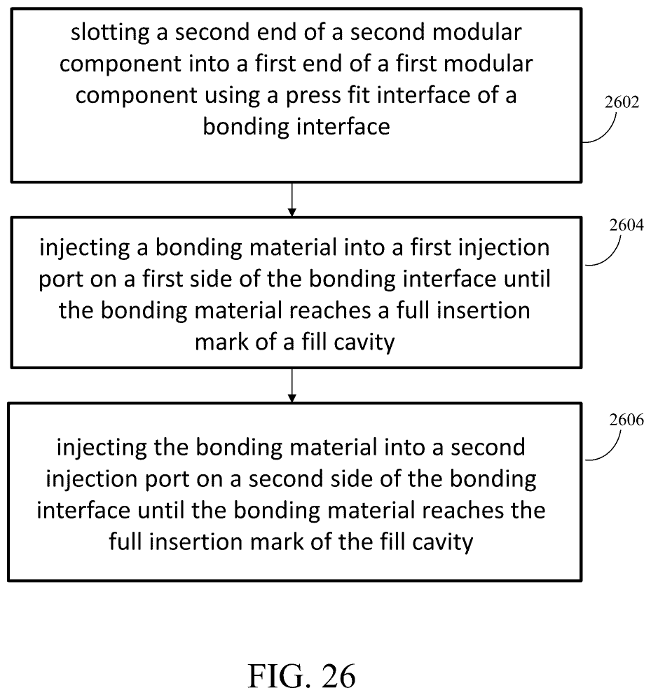

FIG. 26 is a flowchart of an exemplary method for bonding modular components of an additively manufactured vascular network in accordance with an embodiment of the present disclosure. In step 2602, a second end (e.g., end 2512) of a second modular component is slotted into a first end (e.g., end 2510) of a first modular component using a press fit interface (e.g., press fit interface 2506) of a bonding interface (e.g., bonding interface 2500). In an embodiment, full insertion mark 2504 is used to ensure proper press fit engagement. In step 2604, a bonding material is injected into a first injection port (e.g., a first injection port of 2x injection port 2508) on a first side of a bonding interface until the bonding material reaches a full insertion mark (e.g., full insertion mark 2504) of a fill cavity (e.g., fill cavity 2502). In step 2606, the bonding material is injected into a second injection port (e.g., a second injection port of 2x injection port 2508) on a second side of the bonding interface (e.g., bonding interface 2500) until the bonding material reaches the full insertion mark (e.g., full insertion mark 2504) of the fill cavity (e.g., fill cavity 2502).

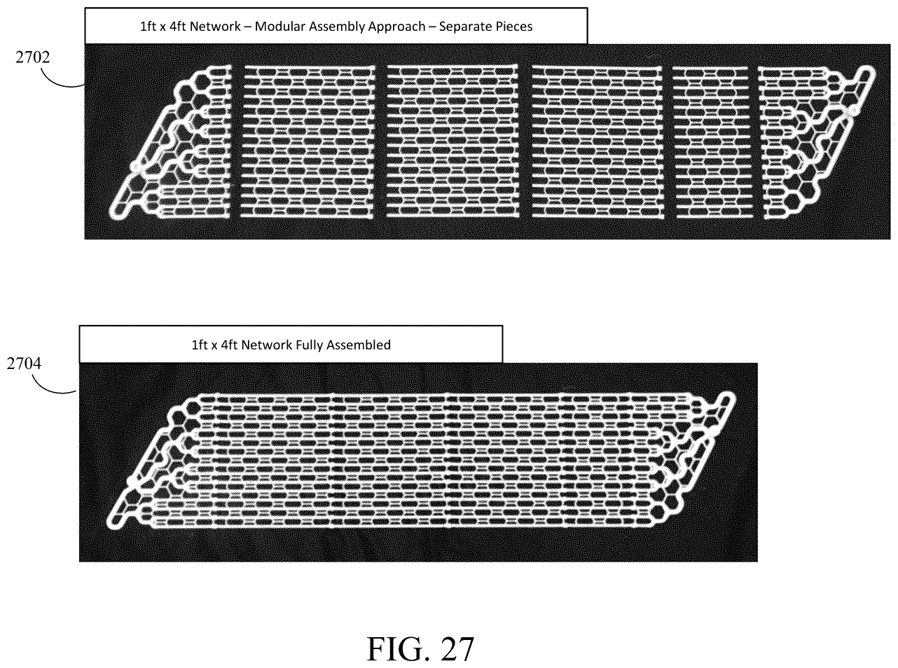

FIG. 27 is a diagram showing assembly of modular components of an additively manufactured vascular network in accordance with an embodiment of the present disclosure. FIG. 27 shows a first image 2702 of separate pieces of modular components of an additively manufactured vascular network in accordance with an embodiment of the present disclosure and a second image 2704 showing these pieces bonded together (e.g., using the bonding systems and methods described with reference to FIG. 25).

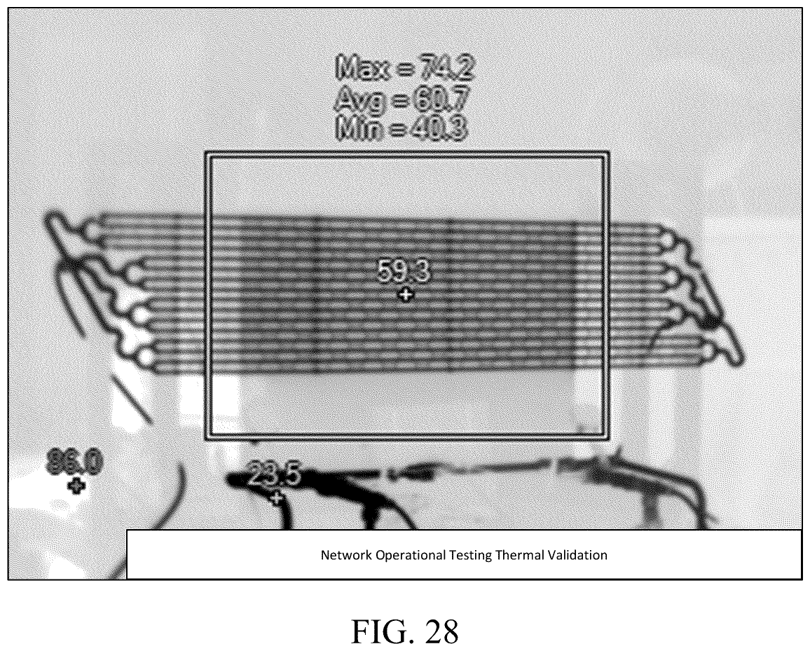

FIG. 28 is a thermal camera image for thermal testing of an additively manufactured vascular network in accordance with an embodiment of the present disclosure. The thermal camera image of FIG. 28 shows no blocked channels after thermal validation is performed.

In an embodiment, the modular approach described above rapidly decreases the complexity of cleaning support material because, for example, modular components can be de-coupled, cleaned, and recoupled if necessary. Additionally, modular pieces decrease the complexity of cleaning support or uncured resin because of the simpler flow paths of individual pieces. In an embodiment, the additively manufactured approach described above can better accommodate 2 phase liquids than conventional approaches. For example, in an embodiment, a 2 phase liquid can change between gas and liquid and can operate at higher pressures, and these higher pressures can be accommodated without any stress concentrations from the manufacturing process using an additively manufactured vascular network in accordance with an embodiment of the present disclosure. For example, in an embodiment, high pressure can be accommodated using additively manufactured circular cross sections. In an embodiment, the additively manufactured approach described above can also accommodate a single phase flow either liquid or vapor.

Further, a modular additively manufactured vascular network in accordance with an embodiment of the present disclosure can better support walls of varying thicknesses. For example, a smaller wall thickness be used when cross-sectional areas are smaller and smaller forces are present, smaller wall thickness provides increased thermal conductivity and decreased weight. Large cross-sectional areas from inlet/outlet regions can require larger thickness for equivalent factors of safety. Embodiments of the present disclosure using additively manufactured vascular networks can vary wall thicknesses to maximize thermal conductivity and weight while still allowing larger wall thicknesses when necessary (e.g., for larger cross-sectional areas and the associated loads from pressure containment requirements). Further, embodiments of the present disclosure can gradually increase or decrease wall thicknesses along the length of a wall as design needs change along the length of a wall (e.g., based on varying forces present along the walls of the network or to provide smooth transitions in turning of the flowpath).

An additive manufacturing approach in accordance with an embodiment of the present disclosure can remove stress concentrations caused by conventional approaches and can increase performance by allowing larger cross sections and/or thinner walls. In an embodiment, a circular cross section can be integrated for much better pressure containment. In an embodiment, an additive approach in accordance with an embodiment of the present disclosure allows for unique geometry such as variable wall thicknesses (smaller wall thickness for smaller cross section) reducing weight. In an embodiment, a pressure inlet/outlet interface can be designed as all one piece, reducing complexity. In an embodiment, networks can be printed as tubes with no material in between channels to reduce weight and allow for higher assembly stack ups such as casting into other materials. Embodiments of the present disclosure increase thermal performance by allowing tighter channel spacing compared to other approaches. Embodiments of the present disclosure require no custom tooling, enabling fast adjustments to custom geometry. A modular approach in accordance with an embodiment of the present disclosure allows for small sections to be printed on inexpensive machines. In an embodiment, modular components can be bonded together using adhesives such as epoxy resins or UV cure resins from the parent material. In an embodiment, a bond interface in accordance with an embodiment of the present disclosure allows for bond sites to be injected with adhesive and verified visually as fully bonded to seal against pressure.

### 7. Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A method for creating a vascular network structure, the method comprising:
receiving a design for a one-piece continuous vascular network structure, wherein the design defines an internal cavity that can be circular, ob-round, or ellipsoidal, and wherein the design defines varying wall thickness throughout the one-piece continuous vascular network structure;
three dimensionally (3D) printing the one-piece continuous vascular network structure based on the design, wherein the continuous vascular network structure defines at least one fluid channel extending through the continuous vascular network structure and at least one channel opening;
flushing uncured resin from the at least one channel; and
performing a flow test with a fluid to determine whether the fluid can flow through the entirety of the at least one fluid channel.

2. The method of claim 1, further comprising curing the continuous vascular network structure.

3. The method of claim 1, further comprising conducting a proofing test (e.g., pressure test) to determine structural integrity of the continuous vascular network structure.

4. The method of claim 1, wherein the flushing comprises:
forcing a fluid through the at least one fluid channel air or liquid to clear the uncured resin from the at least one channel.

5. The method of claim 1, wherein the flushing comprises:
inserting at least one magnetic object in the at least one channel opening; and
moving the at least one magnetic object through an entirety of the at least one fluid channel via magnetic force applied by a magnet, thereby clearing the uncured resin from the at least one fluid channel via the magnetic object.

6. The method of claim 1, wherein the one-piece continuous vascular network structure is a branching structure with multiple channels.

7. The method of claim 1, wherein the one-piece continuous vascular network structure is configured to carry fluid at a temperature of between −40° C. and 70° C.

8. The method of claim 1, wherein the one-piece continuous vascular network structure is configured to carry fluid at a temperature of over 70° C.

9. The method of claim 1, wherein the one-piece continuous vascular network structure is configured to carry fluid at a temperature of below −40° C.

10. The method of claim 1, wherein the one-piece continuous vascular network structure is configured to withstands an internal pressure of between 300-2000 pounds per square inch (psi).

11. A modular additively manufactured vascular network, comprising:
a first modular component of the additively manufactured vascular network, wherein the first modular component has a bonding interface positioned at a first end of the first modular component, wherein the additively manufactured vascular network comprises a plurality of tubes that are configured to support internal pressures caused by a 2 phase liquid flowing through the tubes, and wherein the 2 phase liquid is configured to enable the modular additively manufactured vascular network to support thermal management; and
a second modular component of the additively manufactured vascular network, wherein a second end of the second modular component is slotted into a first end of the first modular component at a press fit interface of the bonding interface, wherein the bonding interface includes:
a first injection port on a first side of the bonding interface;
a second injection port on a second side of the bonding interface; and
a bonding material filling a fill cavity of the bonding interface up to a full insertion mark, wherein the bonding material bonds the first modular component to the second modular component.

12. The modular additively manufactured vascular network of claim 11, wherein the first modular component and the second modular component are three dimensionally (3D) printed components.

13. The modular additively manufactured vascular network of claim 12, wherein the first component comprises a circular internal cavity.

14. The modular additively manufactured vascular network of claim 12, wherein the first component comprises an ob-round internal cavity.

15. The modular additively manufactured vascular network of claim 12, wherein the first component comprises an ellipsoidal internal cavity.

16. The modular additively manufactured vascular network of claim 12, wherein a tubing of the first component has varying wall thickness throughout the tubing.

17. The modular additively manufactured vascular network of claim 11, wherein the modular additively manufactured vascular network is configured to carry fluid at a temperature of between −40° C. and 70° C.

18. The modular additively manufactured vascular network of claim 11, wherein the modular additively manufactured vascular network is configured to carry fluid at a temperature over 70° C. and below −40° C.

19. The modular additively manufactured vascular network of claim 11, wherein the modular additively manufactured vascular network is configured to withstand an internal pressure of between 300-2000 pounds per square inch (psi).

20. A heat transportation system, comprising:
a condenser;
a compressor coupled to an input of the condenser;
a thermal expansion valve coupled to an output of the condenser; and
a modular additively manufactured vascular network coupled to an output of the thermal expansion valve and to an input of the compressor, the modular additively manufactured vascular network comprising:
a first modular component of the additively manufactured vascular network, wherein the first modular component has a bonding interface positioned at a first end of the first modular component, wherein the additively manufactured vascular network comprises a plurality of tubes that are configured to support internal pressures caused by a liquid or a gas flowing through the tubes, and wherein the liquid or the gas is configured to enable the modular additively manufactured vascular network to support thermal management, and
a second modular component of the additively manufactured vascular network, wherein a second end of the second modular component is slotted into a first end of the first modular component at a press fit interface of the bonding interface, wherein the bonding interface includes:
an injection port on the bonding interface; and
a bonding material filling a fill cavity of the bonding interface up to a full insertion mark, wherein the bonding material bonds the first modular component to the second modular component.
